(19) United States
(12) Patent Application Publication
(10) Pub. No.: US 2010/0031148 A1
(43) Pub. Date: Feb. 4, 2010

(54) COMMUNITY-ORIENTED SOCIAL NETWORK

(76) Inventor: Ramon Rivera, Brentwood, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/535,392

(22) Filed: Aug. 4, 2009

Related U.S. Application Data
(60) Provisional application No. 61/085,975, filed on Aug. 4, 2008.
(60) Provisional application No. 61/096,934, filed on Sep. 15, 2008.

(51) Int. Cl. G06F 3/01

(52) U.S. Cl. 715/716; 715/753; 715/764

(57) ABSTRACT

A method for location-based social networking, comprising steps of accessing an interface of a social-networking system, determining a location, displaying information about the location on a monitor, and interacting with the information, wherein interacting comprises at least rating the information. In one embodiment, accessing is performed by logging in to an account to determine the location. The displayed information can include information about clothing, marketplaces, self-serve advertisements, digital gifting, billing, ask-around information, and public events. Broadcasting music based on the location can be performed. Interacting with other system users by video chatting, audio chatting, and instant messaging can be performed. The information can be searched. The information can be displayed in multiple languages in accordance with the location.

### CROSS REFERENCE TO RELATED APPLICATIONS

The present invention claims the benefit of U.S. provisional patent application 61/085,975 filed Aug. 4, 2008, and of U.S. provisional patent application 61/096,934 filed Sep. 15, 2008, and the entire contents and disclosure of both are incorporated herein by reference as if fully set forth herein.

### FIELD OF THE INVENTION

The present invention relates generally to community oriented social networking.

### SUMMARY OF THE INVENTION

An inventive system and method for community oriented social networking is presented.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a print out of a sample home screen of the web site in accordance with the present invention; and

FIG. 2 shows the ATW—third party relationship in accordance with the present invention; and

FIG. 3 is a flow diagram of the inventive method.

### DETAILED DESCRIPTION

An inventive system, method, architecture and apparatus for community oriented, location specific social networking are provided as disclosed in the following description. The inventive social network enables users, in accordance with their location, to rate virtually all of the networked information.

Various aspects of the present disclosure may be embodied as a program, software, or computer instructions embodied in a computer or machine usable or readable medium, which causes the computer or machine to perform the steps of the method when executed on the computer, processor, and/or machine.

System and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, etc.

The inventive social network, which can be implemented as a web site, comprises a main web site accessible destination for web, mobile and administrative users. The web site, which can be displayed on a monitor of a computer, has an established look and feel. Non-key pages will follow the same flow, look and feel established in their “parent” pages. The following features and options are included in the web site of the inventive social network.

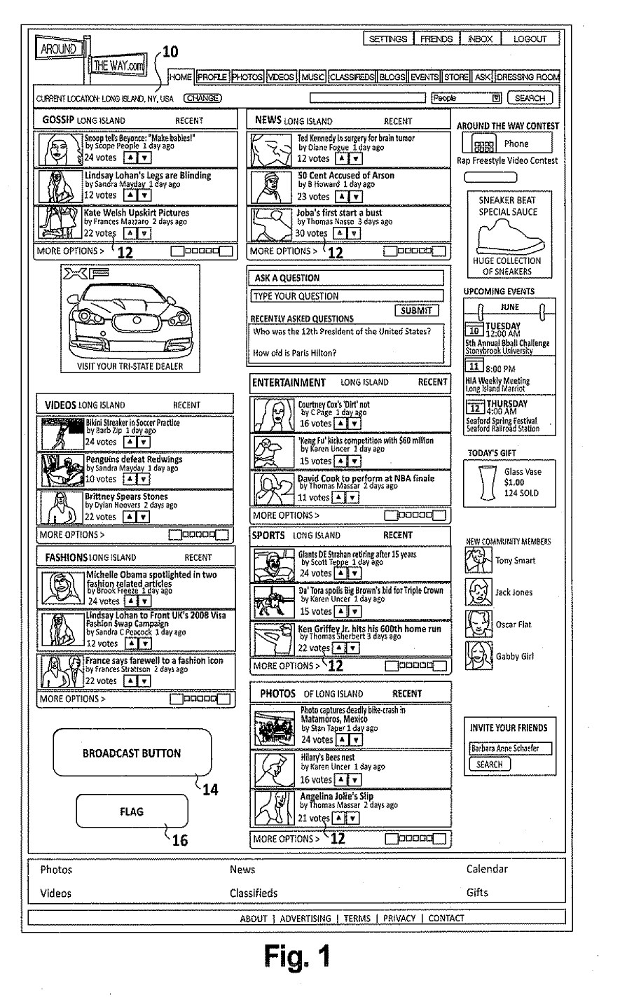

AroundTheWay.com (“ATW”), an exemplary web site, can power the main, localized user generated context. FIG. 1 is a print out of a sample home screen of the web site. The user's location 10 and rated content 12 are shown. Logged-in users can post mixed-media content, such as text, links, images, and videos, as one single post. Along with the content, users can tag or mark the content with a date, location, and keywords which will allow presentation of the content on relative pages and searches.

Locale detection automatically detects a user's location 10 based on where they are accessing the Internet. An Internet technology known as “GeoIP” can be used for this feature. If a user wishes to change his or her location, he or she will be able to override the detected locale setting. Typically, registered users set their local setting in their profile. By automatically detecting a user's location, the most popular, current local content available on the web site becomes instantly available to the user.

The Rated Content 12 feature enables all public user-generated content to be commented on and rated by registered members. As a global function, this sets the stage for populating regional content based on feedback, creating “best-of's” (town, county, state, region, country) as well as creating contests based on rated content 12.

Shared public event calendars are available to registered users, providing access to a fully functional calendar where they can post public and private events. Users can elect to share their calendars with other people using a standardized protocol, such as iCal. The standardized protocol enables all events to have a link back to their respective event page on the web site.

The Global Search feature provides users with the ability to search all content based on predefined searchable fields. Results will be returned organized by content type, such as profiles, videos, events, and/or news. The results will be initially returned by relevance, and the results can be further filtered by, for example, rated content and most recent.

Multi-lingual support is accomplished by allowing for all of the administration generated content to be managed through a database, where all copy is associated with a language base. Navigational items can be text-based buttons. Imagery can be associated with a language style.

Ad Server Integration is offered through configured advertising space throughout the system's web site. One embodiment uses the popular Open Source Ad Server “OpenX Ads”. Cross promotion of sections within the web site is available. The password protected ad management area can be distinct from the web site and system administration.

Users have the ability to interact with each other through networking and rich-media. The following social features can be integrated into a user's account.

User Profile—after registration, users can provide additional identifiable and searchable information about themselves, including name, gender, race, age, location, relationship status, likes, dislikes, music, movies, high school, college, and settings, e.g., public, private, notifications.

Business profile—a user may identify him/her self as a business. Additional fields for businesses, that will also enable the user to appear in a business specific search, can include address, phone, fax, website, industry classification, about the business, and hours of operation. Business listings with a supplied address can be integrated with Google Maps, for example using their third party application program interface or API. Business profiles can integrate with the “One-off and Subscription Billing” functionality, described below, such that premium business listing space can be sold by the web site.

Businesses that sign up under the business profile have the ability to make their web sites their profile, instead of using the default profile. In other words, businesses have a choice of whether to use their own web site as their profile or to use the system's default profile. If a business chooses to use its own web site, the inventive system will automatically obtain the web site of the business when the business' profile is desired. The web site of the business can be embedded on the inventive system. Thus, when a user searches for and finds this business, the user will never leave the inventive system.

Messaging—integrated virtual email is available between members. Registered members can elect to receive new mail notifications. Note that all mail interaction may require users to login to the web site to view their mail. Since the messaging can be web site based, users will have the same posting abilities as the web site, allowing users to send text, images, videos, and events. Video messaging and link sharing are included. Video messaging can allow a user to record a video using the same technology employed by the Video chat, discussed below.

Photo gallery—registered users can upload photos, organized by albums. Images and albums can have rated content, and can be sent to friend(s), and viewed on a mobile device, such as a mobile phone, PDA, etc.

Video Gallery—registered users can upload videos, which can be organized by “channels”. Similar to photos, videos and channels can have rating content, send to friend, and view on my mobile capabilities. Videos can be marked as public or private, and can be tagged, dated, and described. Users can comment on public videos, and can flag videos as inappropriate.

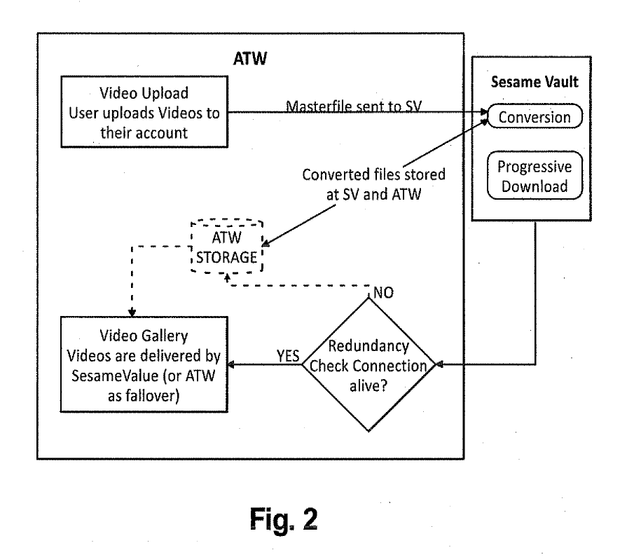

In order to effectively serve videos, third party provides can be used. One such provider is Sesame Vault, but other providers are also available. Such third party providers enable cost effective conversion and progressive video downloads, which keep both costs and server complexity low. Users can upload videos directly through their login account, after which files will be queued for processing, transcoded, and optimized by the third party. On completion, a copy of the files will be returned to the ATW servers. This provides backup or failover in the event of disruption between ATW and the third party provider, and permits in-house processing of videos, if desired. FIG. 2 shows the ATW—third party relationship.

Networking allows registered members to search for other members, request relationship acknowledgement, and indicate a predefined relationship description, e.g., “relative”, “from my neighborhood”, “know from school”, etc. Members who indicated a relationship between each other can have extended privileges with respect to each other. Related members will be able to comment on each other's photos, see if the other, related member is online, and request a video chat.

In addition to the above social features, the system offers instant messaging, as well as audio and video chat. The video chat will enable users to chat with other registered members while browsing the internet, that is, users can continue to browse the web site while chatting. Chatting users will have the ability to exchange links within the system, allowing them to show each other aspects of other sections of the web site.

The chat experience supports registered members only. Users can have the ability to have a many-to-many chat experience with other registered members. In one embodiment, a user can chat with three other members. The chat application can be browser based. For example, it can be driven by a free common plug-in such as Adobe Flash. Logged in, registered members can initiate a chat with other members and can block or flag chat requests from other users.

The video chat can utilize a “credits” system corresponding to each registered user or member. Integration with the “rated content” feature, described above, as well as the “one-off and subscription payments” feature, described below, is thus provided. “Video credits” can be assigned to active users based on usage or payment criteria. Users can see remaining “credits” and can use video chat and be prompted to add more “credits” should they run out.

Instant Messaging (“IM”) can occur within the same chat interface. Users can choose whether or not to chat using video and IM, or just IM.

Clothing Application

The Clothing Application allows members to browse and select clothing items to assemble a collection of clothing into “outfits”. Several outfits make up a “closet”, and a “wardrobe” consists of all of the user's clothing items. Members can create outfits by browsing clothing within the clothing application.

The clothing application browses the available clothing items in an “online shopping”-like experience. Clothing can be browsed by various categories including Type (e.g., shirts, pants, hats), Color-Way (e.g., reds, blues, greens), Brand, Season, and/or gender.

While browsing, users can add clothing items to their wardrobe, or place items in their virtual dressing room, and recommend items to other users in the system. Once an item is available to a user in his or her wardrobe, it can be used in one or more than one outfits.

The clothing application can be driven by administration-added clothing items in a predefined format. In addition, administration can enter item specific details for each component or item. These details include name, description, color name, color-way (from available swatches), brand, image(s), brand website, and/or affiliate/resale link. In one embodiment, the images are limited to five per item.

An Outfit Builder interactive component can be associated with the system. Outfit Builder can use a combination of technologies including, for example, client and server-side Javascript, and Flash where necessary. Users can create an outfit based on selecting items from their wardrobes, and allocating specific items to predefined available slots. In one embodiment, the following items comprise an outfit: Hat/cap, jacket/coat, shirt/sweater, shorts/pants, belt, socks, and shoes.

Using clothing information and ratings 12 from users, “trend reports” can be created. These reports can indicate what is popular or highly rated in various geographic locations and/or based on gender and/or age. A typical trend report can have most popular outfits, color, clothing item(s) including outfits and individual items, and/or designer(s). The reports can be produced periodically, such as daily, weekly, monthly, etc., and can be used to identify trends. In one embodiment, these reports can be provided to designers so they can know what people actually use, which will help the designers make better decisions.

Mobile

The system can include a mobile destination or mobile component that can give users an optimized experience on their mobile device such as a cell phone, iPhone, or PDA. The mobile component features a scaled down version of the traditional web site experience. In one embodiment, users can interact with the following features in a mobile optimized format: Login/register, browse contents and profiles, view downloadable video and/or photos, search, perform messaging, access the marketplace, and/or access the clothing application.

The mobile component or platform can optimize content for mobile devices, content transcoding, device detecting, and delivery. Additionally, the platform can offer saleable digital items such as wallpapers, animated gifs, ringtones, and videos.

Marketplace

In a marketplace component, registered users or members can post buy/sell information of a product or service, which other members or non-members can inquire about and/or purchase. Some information that can be posted includes title, description, image, price, and/or video. Users, as buyers, can add items to their watch lists, be notified about price changes, contact the seller, and make an offer to the seller. Users, as sellers, can view how many people are watching an item and how many people contacted the seller in relation to the listing. The seller-user can also select a user who indicated interest as a buyer, and the seller-user can mark the item sold. Users can have a distinct “wish list” category, in which a list of “wanted” items is maintained.

The marketplace can be integrated into the mobile component, described above, such that both buyers and sellers have the same available functionality as the traditional web site, optimized for a mobile device.

Self-Service Advertising Space

Registered users can purchase advertising space on the web site using built-in billing. Users can write a text ad and/or upload an image ad as well as select delivery location, total number of impressions, scheduling and click through address. Users can remove or re-add advertisements during the payment process. Administration can review all running advertisements, and edit or remove advertisements as necessary, as well as obtain revenue reports on advertisement sales.

Digital Gifting

A user can send a digital “gift”, either as image, video, or audio. Users can select from content added by administration, who sets pricing and availability. Digital gifts can be placed in a designated area in the recipient user's profile. The recipient can be notified via email of the gift. In addition, users can archive and/or hide gifts.

One-Off and Subscription Billing

The web site can accept credit card and “paypal” payments, for example in the traditional web site as well as the administration and management area. This enables administration to set pricing to specific features of the web site, and to collect revenue.

Ask Around

Users are able to “ask” a question to the community and receive multiple answers of which they can select one as the “accepted” answer. There can be visual indication of a new question asked since last login next to the “ask” button in the top navigation.

Broadcast Feature

Referring again to FIG. 1, which is a print out of a sample home screen of the web site, the user's location 10, user rated content 12, and broadcast feature 14 are shown. The broadcast feature 14, which can operate like a traditional radio station, can have all types of music categories. The broadcast feature 14 can include several segments or sections for each type of music, including “newest songs uploaded”, “most recent”, “top rated”, etc. In addition, an individual user can create a “play-list”, that is, a segment of a fixed number, typically five, of his or her favorite songs or content. The user can also change the items in the play-list.

Logged-in users can upload and post sound content, for example songs, as wave files, links, etc. The content can be composed and/or written by the user or by someone else, if permissible. Users can tag or mark the content with a date, location, and keywords that will allow presentation of the content on relevant pages and searches. Once submitted, the content will then become available on the “newest songs uploaded” segment where ATW users can hear it and rate it.

The Rated Content 12 feature enables the sound content to be commented on and rated by registered members. As a global function, this sets the stage for populating regional content based on feedback, creating “best-of's” (music type, town, county, state, region, country) as well as enabling the creation of contests based on rated content 12.

The broadcast feature 14 continuously broadcasts a rotation or rotating collections of items or content, one rotating collection for each type of music or channel, e.g., hip hop, rap, pop, rock, alternative, etc. The frequency with which an item from the rotating collection is broadcast is determined by the item's popularity in accordance with its rating. Initially, when an item is rated positively, it can automatically enter into the rotation of the appropriate channel. Once the song enters the rotation, users that are hearing that particular channel can also rate the song. A highly rated song will keep its popularity, enabling it to remain one of the songs played frequently in the rotation. If a song or item is not yet popular, then positive feedback indicated through the rating feature, that is positive ratings, will allow the song to increase its frequency of play or “climb the rotation”.

Conversely, content, including items or songs, that receives negative feedback can have its frequency of play in the rotation decreased or can “come down from the rotation”. Further, content that elicits no response, that is, items that are not rated positively or negatively but are simply ignored, can slowly come down from the rotation.

The broadcast feature 14 can continue to transmit while the users are browsing the web or ATW site, regardless of what web page they click to or what they do while on the site.

Not only will users be able to receive the broadcast rotation, they will also have the ability to request content. In one embodiment, a user could issue one request per category every two weeks. Further, a specific song or item can be requested, if desired, using a particular section of the site. Moreover, a user could choose a set of items to hear in sequence or “back to back”. In one embodiment, a user could select up to five items in a set. Selection of an item, as a specific request or to be included in a play-list, is positively reflected in its rating, even if the rating process is not performed for the item.

In addition to user-provided content, audible advertisements can be provided. These “audio ads” can be broadcast via the broadcast feature 14. In one embodiment, an audible advertisement can be placed in the rotation and can be broadcast or played after every five songs or items. The ads can be limited in length to, for example, less than ten seconds. In one embodiment, the ads can play immediately before the songs begin; in another embodiment, they can play after the third song ends.

The inventive system can include a flag button 16 in conjunction with the broadcast feature 14. This flag button 16 enables a user who selects content to flag and report it as INAPPROPRIATE or WRONG CATEGORY. Inappropriate items could be, for example, those using obscene language. Wrong Category can indicate an item submitted in an incorrect category, such as a hip hop song submitted as rock, etc.

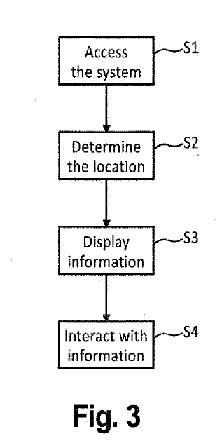

Operation of the inventive system is shown in FIG. 3. Initially, a user accesses the system, in step S1. User access is typically performed using a log-in process in which a user activates his or her account on the web site. The user's location is determined in step S2. As described above, the location can be determined using “GeoIP” or other technology, or the user can enter his location directly. Information in accordance with the user's location is displayed on the user's monitor in step S3. In step S4, the user can interact with this information, including rating the information, interacting with other users, accessing broadcast music, etc.

Exemplary features and components are shown in Appendix B.

Exemplary screen shots are shown in Appendix C.

An exemplary site map is shown in Appendix D.

The embodiments described above are illustrative examples and it should not be construed that the present invention is limited to these particular embodiments. Thus, various changes and modifications may be effected by one skilled in the art without departing from the spirit or scope of the invention.

What is claimed is:

1. A method for location-based social networking, comprising steps of:
accessing an interface of a social-networking system;
determining a location;
displaying information about the location on a monitor; and
interacting with the information, wherein interacting comprises at least rating the information.

2. The method according to claim 1, wherein the step of accessing is performed by logging in to an account, wherein the account determines the location.

3. The method according to claim 1, wherein the information displayed includes at least one of clothing information, marketplace information, self-serve advertisement information, digital gifting information, billing information, and ask-around information.

4. The method according to claim 1, further comprising a step of broadcasting music based on the location, said broadcasting occurring simultaneous with said interacting with the information.

5. The method according to claim 1, further comprising a step of interacting with users of the social-networking system by one or more of video chatting, audio chatting, and instant messaging, said interacting with users occurring simultaneous with said interacting with the information.

6. The method according to claim 1, wherein the step of interacting with the information further comprises searching the information.

7. The method according to claim 1, wherein the information is displayed in more than one language in accordance with the location.

8. The method according to claim 1, wherein the information includes a public event calendar.

9. The method according to claim 1, said step of interacting with the information further comprising populating a wardrobe and sharing the wardrobe with users.

10. The method according to claim 1, further comprising a step of creating a trend report using the information.

11. A computer readable medium having computer readable program for operating on a computer for location-based social networking, said program comprising instructions that cause the computer to perform the steps of:
accessing an interface of a social-networking system;
determining a location;
displaying information about the location on a monitor; and
interacting with the information, wherein interacting comprises at least rating the information.

12. The program according to claim 11, wherein the step of accessing is performed by logging in to an account, wherein the account determines the location.

13. The program according to claim 11, wherein the information displayed includes at least one of clothing information, marketplace information, self-serve advertisement information, digital gifting information, billing information, and ask-around information.

14. The program according to claim 11, further comprising a step of broadcasting music based on the location, said broadcasting occurring simultaneous with said interacting with the information.

15. The program according to claim 11, further comprising a step of interacting with users of the social-networking system by one or more of video chatting, audio chatting, and instant messaging, said interacting with users occurring simultaneous with said interacting with the information.

16. The program according to claim 11, wherein the step of interacting with the information further comprises searching the information.

17. The program according to claim 11, wherein the information is displayed in more than one language in accordance with the location.

18. The program according to claim 11, wherein the information includes a public event calendar.

19. The program according to claim 11, said step of interacting with the information further comprising populating a wardrobe and sharing the wardrobe with users.

20. The program according to claim 11, further comprising a step of creating a trend report using the information.
